(19) United States
(12) Patent Application Publication
(10) Pub. No.: US 2004/0101351 A1
(43) Pub. Date: May 27, 2004

(54) Lock arrangement for telescoping poles

(76) Inventor: David E. Pitcher, Cambridge, MA (US)

Correspondence Address: Donald N. Halgren, 35 Central Street, Manchester, MA, 01944, US

(21) Appl. No.: 10/302,280

(22) Filed: Nov. 22, 2002

(51) Int. Cl. F16B 7/10

(52) U.S. Cl. 403/109.5

(57) ABSTRACT

A lock arrangement for a pair of telescoping poles comprising an elongated generally cylindrically shaped housing having a bore extending longitudinally therethrough with an inner channel arranged at one end of the bore. An outer channel is arranged in an outer surface of the housing. An opening is arranged in the housing between the inner channel and the outer channel for receipt of a bias lever arranged therethrough from the inner channel.

### BACKGROUND OF THE INVENTION

1. Field of the Invention

This invention relates to locks for telescoping poles and more particularly to bias locks between a first and a second mating pole which lock is minimal in its complexity.

2. Prior Art

Adjusting the longitudinal dimension of an elongated object such as a stand or support leg is a common occurrence in business and in industry. Such longitudinal adjustment may take the place of clamps which squeeze the periphery of one member about another, threaded adjustment means and hinged levers which pinch and bind one object with respect to another.

In certain uses of such locking devices, however, those devices should be minimally obtrusive, very easily operable, and effective without marking or damaging the service of the longitudinal components being locked together. Such a locking arrangement is necessary particularly in the advertising end display industry where attractiveness is important and distraction from the business entity or advertising is minimized.

It is thus an object of the present invention to provide a lock for a telescoping pole arrangement which overcomes the disadvantages of the prior art.

It is a further object of the present invention to provide an attractive minimally obtrusive lock or engaging a pair of telescoping poles.

It is a further object of the present invention to provide a lock or telescoping poles which minimizes the number of components utilized therein and simplifies the design to accomodate the needs of the advertising and business and user.

### BRIEF SUMMARY OF THE INVENTION

The present invention comprises a telescoping pole lock assembly where a first elongated pole of a first diameter is arranged to telescopingly receive a first end of a second pole of a smaller diameter. The first pole will have a first or uppermost end with a pole lock arrangement mounted thereon.

The pole lock arrangement comprises a generally cylindrically shaped housing having a first or lower end which mates about the first end of the first pole. The housing has a bore extending therethrough. An annular shoulder is arranged about a midpoint of the bore extending through the annular housing of the pole lock assembly, which shoulder abuttingly receives the distalmost first end of the first pole. The second end of the pole lock housing is arranged to receive the second pole. The second end of the housing has an inner diameter of the bore corresponding to the smaller outer diameter of the second pole. The first and second poles have a common longitudinal axis and a common center line extending therethrough.

The housing of the pole lock arrangement has on one side thereof, an outer channel extending generally parallel to the longitudinal axis of that housing. The outer channel extends from the first end of the housing up to a bar extending across the uppermost or second end of the outer channel.

An inner groove or channel is arranged in a second end of the housing radially adjacent the outer channel of that housing. The inner channel has a distalmost end which defines a lip of an arcuate segment of the annular shoulder at the midpoint of the bore in the housing. The inner channel is defined by a pair of opposed parallel sidewalls having a step or shoulder at their distalmost end. A cutout is arranged in a radially outer surface of the inner groove to provide a pivot point for the receipt of a locking lever therein. A generally rectilinear opening is arranged in the radially facing wall between the inner channel or groove and the outer channel or groove.

A generally “L-shaped” lever having an elongated first end is receivably mated within the outmost channel. The L-shaped lever has a second end which is arranged normal to the plane of the first end of the lever. A pintle extends transversely from each side of the second end of the L-shaped lever. Each pintle is arranged to be received in the cutout in the respective sidewalls between the inner channel and the outer channel. The second end of the L-shaped lever has a curvilinear small-tube-engaging surface thereon. The curvilinear surface is arranged to correspond to the curvilinear surface on the periphery of the second pole.

A chamfer or angled clearance surface is arranged on the second or “short” end of the L-shaped lever to prevent engaging contact between the L-shaped lever and the second pole prior to the engagement of the curvilinear surface thereon when the L-shaped lever is pressed towards the outer channel.

The simplicity of the present of the pole lock includes the fact that only two components comprise such a pole lock arrangement. Those two components are the annular housing and the L-shaped lever. In assembly of the two components, the first end or lowermost “long” end of the L-shaped lever is slid through the rectilinear opening between the first or inner channel and the outer channel where upon the pintles on either side of the L-shaped lever are permitted to enter the respective pivot cutouts in the sidewalls of the inner channel and the outer channel. Once the pintles of the L-shaped lever have been received properly into those cutouts, a first pole may be pushed into the bore at the first end of the pole lock arrangement. The first pole will have its end abut the annular shoulder therewithin. A second pole may then be inserted into the second end of the housing of the pole lock arrangement. The L-shaped lever at that time would be pivoted away from the housing so that the first end of the L-shaped lever is generally “normal” to that housing. The second pole may be inserted into the open end of the first pole within the housing and set to its' desired length. The L-shaped lever may then be pivoted about its axis defined between the pintles, the chamfered surface avoiding contact with the surface of the second pole as the L-shaped lever is pressed (and pivoted) towards the outer channel. The curvilinear surface of the second or short end of the L-shaped lever is thus permitted to frictionally engage and bias the second pole into a locking relationship with respect to the housing of the pole lock arrangement.

Thus what has been defined is a unique pole lock arrangement for a pair of telescopable poles, the first pole having a slightly larger inner diameter to permit the entry therein of a smaller diameter second pole. The locking feature of the pole lock arrangement cannot be removed, fall apart or otherwise be detrimental to the effectiveness of the pole lock arrangement without the telescoping poles being separated from the housing of that pole lock arrangement.

The invention thus comprises a lock arrangement for a pair of telescoping poles comprising an elongated generally cylindrically shaped housing having a bore extending longitudinally therethrough, an inner channel arranged at one end of the bore, an outer channel arranged in an outer surface of the housing, and an opening in the housing between the inner channel and the outer channel for receipt of a bias lever arranged therethrough from the inner channel. The bias lever is of L-shape in cross section, having a first end and a second end, the second end having a tube engaging surface thereon. The bore in the housing may be of a first diameter at one end and a second diameter at a second end of the housing. A pair of cutouts may be arranged between the inner and the outer channels to each receive a pintle of the lever. The second or short pole-engaging end of the lever may have a chamfer thereon to permit the lever to pivot without undesired interference with the short end of the lever with a pole thereadjacent. A shoulder may be arranged in the bore of the housing between the first diameter and the second diameter thereof. A bar may be arranged across a second end of the outer channel. The inner channel may extend from a second end of the bore to the shoulder in the bore. Each of the cutouts for the pintles maintain the lever in the housing when a pair of poles are arranged in the housing.

The inner channel and the outer channel are parallel and spaced radially adjacent one another and are connected by a common opening which is arranged to receive the L-shaped lever therethrough when said lock arrangement is assembled.

The invention may also include a method of lockably adjusting the length of a pair of telescoping poles comprising the steps of: providing an elongated housing with an elongated bore therethrough, the bore being of a first diameter at a first end of the bore and the bore being of a second diameter at a second end thereof; arranging an inner channel on an inner side of the bore at a second end thereof and an outer channel on an outer side of the housing; forming an opening between the inner channel and the outer channel; inserting an L-shaped lever having a first end and a second end into the inner channel and through the opening between the channels; inserting a first diameter pole into the first end of the bore and a second diameter pole into the second end of the bore; and biasing the second end of the lever into locking engagement with one of the poles in the bore. The first or long end of lever may extend beyond the first or lower end of the housing to permit easy access to the long end of the lever to facilitate gripping and pivoting thereof.

The bore in the first end of the housing is of a first diameter and the bore at the second of the housing is of a second diameter to snugly accommodate different diameter poles therewithin. The first diameter bore and the second diameter bore in the housing meet at and define a shoulder at a mid-point within the housing.

The invention may also include a method which may include the steps of: placing a curved surface on the second end of the lever for corresponding engagement between the lever and the pole; forming a pair of pintles on the lever to permit the lever to pivot in between the channels in a pair of cutouts therein.

### BRIEF DESCRIPTION OF THE DRAWINGS

The objects and advantages of the present invention will become more apparent when viewed in conjunction with the following drawings in which:

FIG. 1 is a perspective view of a pole lock arrangement constructed according to the present invention, having a first pole and a second pole arranged therewithin;

FIG. 2 is a side elevational view of the pole lock arrangement shown in FIG. 1 looking radially inwardly towards a locking lever arrangement therewith;

FIG. 3 is a view taken along the lines A-A of FIG. 2;

FIG. 4 is a side elevational view of the pole lock arrangement shown in FIG. 2;

FIG. 5 is a sectional view taken along the lines of B-B of FIG. 4;

FIG. 6 is an end view of the pole lock arrangement which is shown in FIG. 1;

FIG. 7 is an exploded view of the lever and housing in a preassembled configuration;

FIG. 8 is a view similar to FIG. 7 from a slightly different angle and

FIG. 9 is a perspective view of the housing and lever constructed according to the principles of the present invention, without any poles arranged therewithin.

### DETAILED DESCRIPTION OF THE PREFERRED EMBODIMENTS

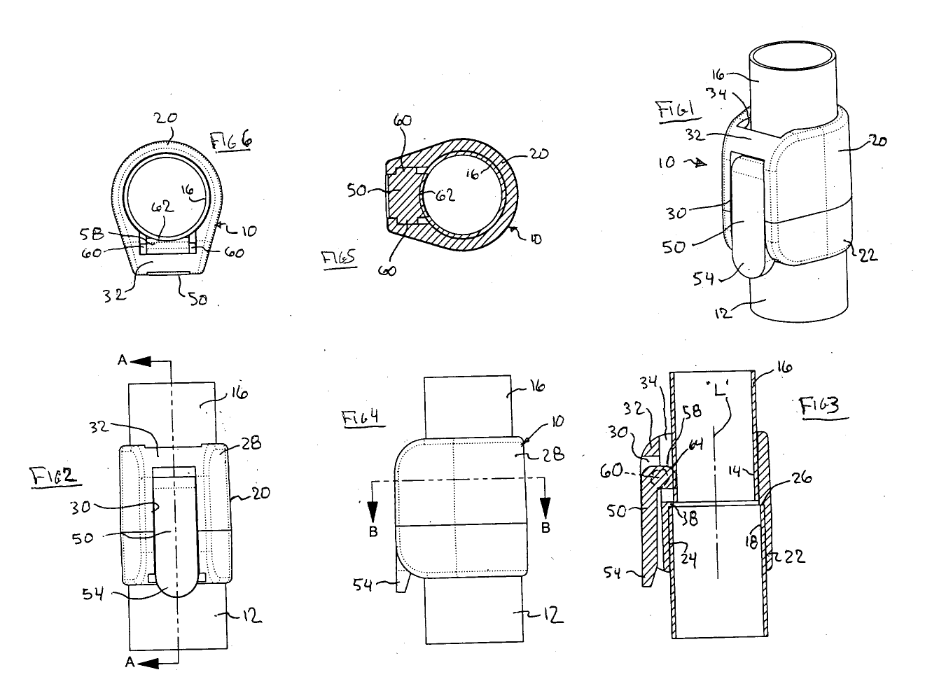

Referring now to the drawings in detail, and particularly to FIG. 1, there is shown the present invention which comprises a telescoping pole lock assembly 10 where a first elongated pole 12 of a first diameter is arranged to telescopingly receive a first end 14 of a second pole 16 of a smaller diameter. The first pole 12 will have a first or uppermost end 18 with the pole lock assembly 10 mounted thereon as shown in FIGS. 1-4.

The pole lock assembly or arrangement 10 comprises a generally cylindrically shaped housing 20 having a first or lower end 22 which mates about the first end 18 of the first pole 12. The housing 20 has a bore 24 extending therethrough, as may be seen in FIGS. 3, 5, 6, 7, 8 and 9. An annular shoulder 26 is arranged about a midpoint of the bore 24 extending through the annular housing 20 of the pole lock assembly 10, as may be seen in FIGS. 3, 8 and 9, which shoulder 26 abuttingly receives the distalmost first end 18 of the first pole 12, as seen in FIG. 3. The second end 28 of the pole lock housing 20 is arranged to receive the second pole 16. The second end 28 of the housing 20 has an inner diameter of the bore 24 corresponding to the outer diameter of the second pole 16. The first and second poles 12 and 16 have a common longitudinal axis “L” and a common center line extending therethrough.

The housing 20 of the pole lock arrangement 10 has an outer channel 30 on one side thereof, as may be seen in FIGS. 1, 2, 3, 5, and 7, which channel 30 extends generally parallel to the longitudinal axis “L” of that housing 20. The outer channel 30 extends from the first end 22 of the housing 20 up to a bar 32 extending across the uppermost or second end of the outer channel 30, as shown in FIGS. 1, 2, 3, 6, 7, 8 and 9.

An inner groove or channel 34 is arranged in the second end 28 of the housing 20 radially adjacent the outer channel 30 of that housing 20, as may be seen in FIGS. 1, 3, and 7-9. The inner channel 34 has a distalmost end 36 which defines a lip 38 of an arcuate segment of the annular shoulder 26 at the midpoint of the bore 24 in the housing 20, as may be seen in FIGS. 3, 8 and 9. The inner channel 34 is defined by a pair of opposed parallel sidewalls 40 and 42, as shown in FIG. 9, having a step or shoulder 44 at their distalmost end, as may be seen in FIG. 8. A cutout 46 is arranged in a radially outer surface of the inner groove 34, as represented in FIG. 8, to provide a pivot point for the receipt of a locking lever 50 therein. A generally rectilinear opening 52 is arranged in the radially facing wall between the inner channel 34 and the outer channel or groove 30, as is represented in FIGS. 7-9.

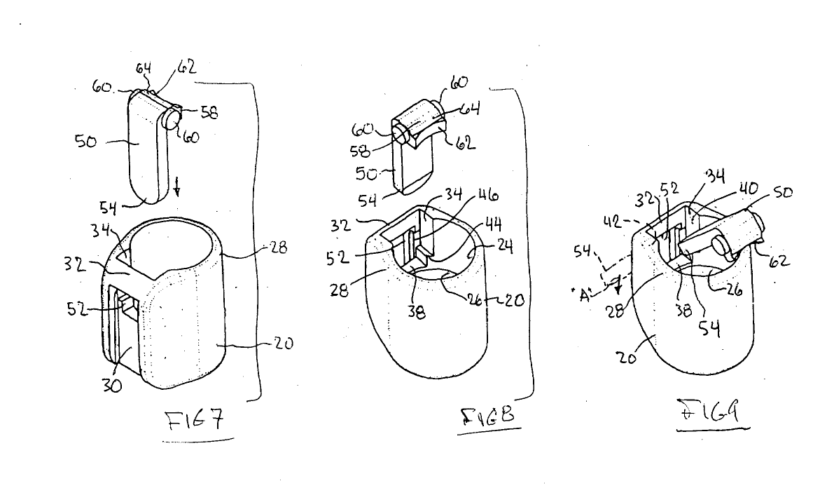

The generally “L-shaped” locking lever 50 has an elongated first end 54 which is receivably mated within the outmost channel 30 as shown in the figures. The L-shaped lever 50 has a second end 58 mwhich is arranged normal to the plane of the first end 54 of the lever 50, as best seen in FIG. 3. A pintle 60 extends transversely from each side of the second end 58 of the L-shaped lever 50, as may be seen in FIGS. 3, 5, and 7-9. Each pintle 60 is arranged to be received in the cutout 46 in the respective sidewalls 40 and 42 between the inner channel 34 and the outer channel 30, as best represented in FIG. 9. The second end 58 of the L-shaped lever 50 has a curvilinear small-tube-engaging surface 62 thereon, as best shown in FIGS. 5, 7 and 8. The curvilinear surface 62 is arranged to correspond to the curvilinear surface on the periphery of the second pole 16.

A chamfer or angled clearance surface 64 is arranged on the second (short) end 58 of the L-shaped lever 50 to prevent engaging contact between the L-shaped lever 50 and the second pole 16 prior to the engagement of the curvilinear surface 62 thereon when the first end 54 of the L-shaped lever 50 is pressed towards the outer channel 30, as represented by the arrow “A” in FIG. 9.

The simplicity of the present pole lock assembly 10 includes the fact that only two components comprise such a pole lock arrangement. Those two components are the annular housing 20 and the L-shaped lever 50. In assembly of the two components, the first end or lowermost end 54 of the L-shaped lever 50 is slid into the inner groove or channel 34 as represented in FIGS. 7 and 8 and then through the rectilinear opening 52 between the inner channel 34 and the outer channel 30, as represented in FIG. 9, where upon the pintles 60 on either side of the L-shaped lever 50 are permitted to enter the respective pivot cutouts 46 in the sidewalls 40 and 42 of the inner channel 34 and the outer channel 30. Once the pintles 60 of the L-shaped lever 50 have been received properly into those cutouts 46, a first pole 12 may be pushed into the bore 24 at the first end 22 of the housing 20 of the pole lock arrangement 10. The first pole 12 will have its end abut the annular shoulder 26 therewithin. A second pole 16 may then be inserted into the second end 28 of the housing 20 of the pole lock arrangement 10. The L-shaped lever 50 at that time would be pivoted away from the housing 20. as represented in FIG. 9, so that the first end of the L-shaped lever 50 is generally “normal” or perpendicular to that housing 20. The second pole 16 may then be inserted into the open end of the first pole 12 within the housing 20 and set to its desired length. The L-shaped lever 50 may then be pivoted about its axis defined between the pintles 60 and 60, the chamfered surface 64 avoiding contact with the surface of the second pole 16 as the long end of the L-shaped lever 50 is pressed towards the outer channel 30. The curvilinear surface 62 of the second end 58 of the L-shaped lever 50 is thus permitted to frictionally engage and bias the second pole 16 into a locking relationship with respect to the housing 20 of the pole lock arrangement 10, as represented in FIG. 3.

Thus what has been defined is a unique pole lock arrangement for a pair of telescopable poles, the first pole having a slightly larger inner diameter to permit the entry therein of a smaller diameter second pole. The locking feature of the pole lock arrangement cannot be removed, fall apart or otherwise be detrimental to the effectiveness of the pole lock arrangement without the telescoping poles being separated from the housing of that pole lock arrangement.

We claim:

1. A lock arrangement for a pair of telescoping poles comprising:
an elongated generally cylindrically shaped housing having a bore extending longitudinally therethrough;
an inner channel arranged at one end of said bore;
an outer channel arranged in an outer surface of said housing; and
an opening in said housing between said inner channel and said outer channel for receipt of a bias lever arranged therethrough from said inner channel.

2. The lock arrangement as recited in claim 1, wherein said bias lever is of L-shape in cross section, having a first end and a second end, said second end having a curvilinear tube engaging surface thereon.

3. The lock arrangement as recited in claim 1, wherein said bore in said housing is of a first diameter at one end and a second diameter at a second end of said housing.

4. The lock arrangement as recited in claim 1, wherein a pair of cutouts are arranged between said inner and said outer channels to each receive a pintle of said lever.

5. The lock arrangement as recited in claim 2 wherein said second end of said lever has a chamfer thereon to permit said lever to pivot without undesired interference by said lever with a pole thereadjacent.

6. The lock arrangement as recited in claim 3 wherein a shoulder is arranged in said bore of said housing between said first diameter and said second diameter thereof.

7. The lock arrangement as recited in claim 1, including a bar arranged across a second end of said outer channel for improving the strength of said housing.

8. The lock arrangement as recited in claim 6, wherein said inner channel extends from a second end of said bore to said shoulder in said bore.

9. The lock arrangement as recited in claim 4 wherein each of said cutouts for said pintles maintain said lever in said housing when a pair of poles are arranged in said housing.

10. A method of lockably adjusting the length of a pair of telescoping poles comprising the steps of:
providing an elongated housing with an elongated bore therethrough, said bore being of a first diameter at a first end of said bore and said bore being of a second diameter at a second end thereof;
arranging an inner channel on an inner side of said bore at a second end thereof and an outer channel on an outer side of said housing;
forming an opening between said inner channel and said outer channel;
inserting an L-shaped lever having a first end and a second or shorter end into said inner channel and through said opening between said channels;
inserting a first diameter pole into said first end of said bore and a second diameter pole into said second end of said bore; and
biasing said second end of said lever into locking engagement with one of said poles in said bore.

11. The method as recited in claim 10, including the step of:
placing a curved surface on said second end of said lever for corresponding engagement between said second end of said lever and said pole.

12. The method as recited in claim 11, including the step of:
forming a pair of pintles on said lever to permit said lever to pivot in between said channels in a pair of cutouts therein.

13. A lock arrangement for locking together of a pair of telescoping poles comprising:
an elongated generally cylindrically shaped housing having a first or lower end and a second or upper end, with a bore extending longitudinally therethrough;
an inner channel arranged at one end of said bore;
an outer channel arranged in an outer surface of said housing; and
an opening in said housing between said inner channel and said outer channel for receipt of a bias lever arranged therethrough from said inner channel, wherein said bias lever is of L-shape in cross section, having a first or long end and a second or short end, said second end having a pole engaging surface thereon, and wherein said bore in said housing is of a first diameter at a first end thereof, and said bore is of a second diameter at a second end of said housing.

14. The lock arrangement as recited in claim 13, wherein said inner channel and said outer channel are parallel and spaced radially adjacent one another connected by a common opening which is arranged to receive said lever therethrough.

15. The lock arrangement as recited in claim 13, wherein said pole engaging surface is curvilinear for proper snug engagement of said lever with a pole thereadjacent.

16. The lock arrangement as recited in claim 13, wherein said first end of said lever extends beyond said first or lower end of said housing to permit access thereto.

17. The lock arrangement as recited in claim 13, wherein said bore in said first end of said housing is of a first diameter and said bore at said second of said housing is of a second diameter to snugly accommodate different diameter poles therewithin.

18. The lock arrangement as recited in claim 17, wherein said first diameter bore and said second diameter bore in said housing meet at and define a shoulder at a mid-point within said housing.
